(19) United States
(12) Patent Application Publication
(10) Pub. No.: US 2016/0012701 A1
(43) Pub. Date: Jan. 14, 2016

(54) SYSTEM AND METHOD FOR A SMART SUBSTANCE DISPENSER SLEEVE

(71) Applicant: Chi Lu, San Francisco, CA (US)

(72) Inventor: Chi Lu, San Francisco, CA (US)

(73) Assignee: Chi Lu, San Francisco, CA (US)

(21) Appl. No.: 14/326,148

(22) Filed: Jul. 8, 2014

(51) Int. Cl. G08B 21/18; A62C 13/00; F41H 13/00; F41H 9/10

(52) U.S. Cl. CPC G08B 21/18; F41H 9/10; A62C 13/00; F41H 13/0012

(57) ABSTRACT

A unitary sleeve configured to encompass at least a portion of a dispenser device and convert the substance dispenser into a “smart” dispenser. An actuator is coupled to the dispenser device and actuated in response to mechanical release of a substance from the dispenser device. A transmitter module is coupled to the actuator and operable to transmit an activation signal to a remote device in response to actuation of the actuator. The remote device communicatively coupled to the transmitter module of the unitary sleeve comprises the “smart” substance dispenser system.

### SUMMARY

According to one aspect, a unitary sleeve configured to encompass at least a portion of a dispenser device includes an actuator coupleable to the dispenser device and actuated in response to mechanical release of a substance from the dispenser device; and a transmitter module coupled to the actuator and operable to transmit an activation signal to a remote device in response to actuation of the actuator.

### BRIEF DESCRIPTION OF THE DRAWINGS

Reference will now be made to the attached drawings, when read in combination with the following specification, wherein like reference numerals refer to like parts throughout the several views, and in which:

FIG. 1 is an illustration of a standard off-the-shelf substance dispenser, according to one embodiment.

FIG. 2A is a three dimensional mechanical illustration of a smart substance dispenser, according to one embodiment.

FIG. 2B is a two dimensional mechanical illustration of the smart substance dispenser of FIG. 2A communicatively coupled to a remote device, according to one embodiment.

FIG. 3 is a flowchart of a setup method for setting up a smart dispensing application on the remote device, according to one embodiment.

FIG. 4 is a flowchart of a panic mode method implemented in response to releasing substance from the smart substance dispenser, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Currently, there are various non-lethal self-defense apparatuses on the market. Some examples include pepper spray (e.g., MACE, PEPPER SHOT, ASP, STREETWISE, WILDFIRE, MAGNUM, or DEFENSE TECH), stun guns, and tasers. The benefit of carrying a non-lethal weapon is that a victim is less reluctant to use such a weapon in times of imminent danger or physical attack than when carrying a lethal weapon. However, the manufacturers of such self-defense weapons (e.g., sprays and tasers) focus on deterring imminent harm but do not address obtaining assistance immediately after use.

One attempt at a smart self-defense apparatus is described in U.S. Pat. No. 8,245,878 (“'878 patent”). The '878 patent describes a substance dispenser that must be specifically manufactured with processing technology and a power source embedded therein. For example, the '878 patent requires an electronic module built into the substance dispenser and obtains power from a battery. The electronic module includes a microprocessor, memories (e.g., ROM, RAM, EPROM), a digital signal processor (DSP), a display, a GPS device, and CMOS image sensors to name a few. This requires substance dispenser manufacturers to alter their design and manufacturing processes to incorporate many additional costly components. These additional embedded components are costly in terms of price, space, weight, and power consumption.

It would be desirable to have a smart substance dispenser that would not require additional internal components and the need to redesign current substance dispensers on the market. Consequently, there is a need for a substance dispenser auxiliary component which could be easily coupled to standard off-the-shelf substance dispensers (e.g. pepper sprays) and leverage processing, memory, and power from existing external devices proximate the substance dispenser.

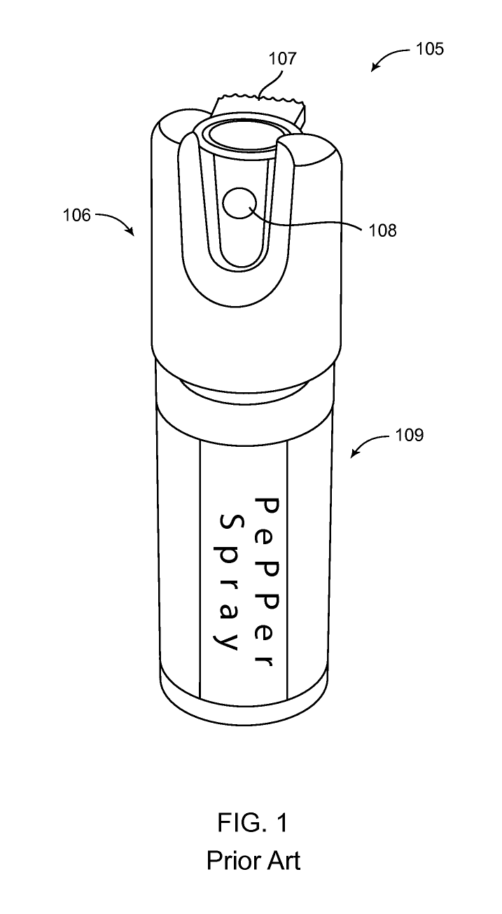

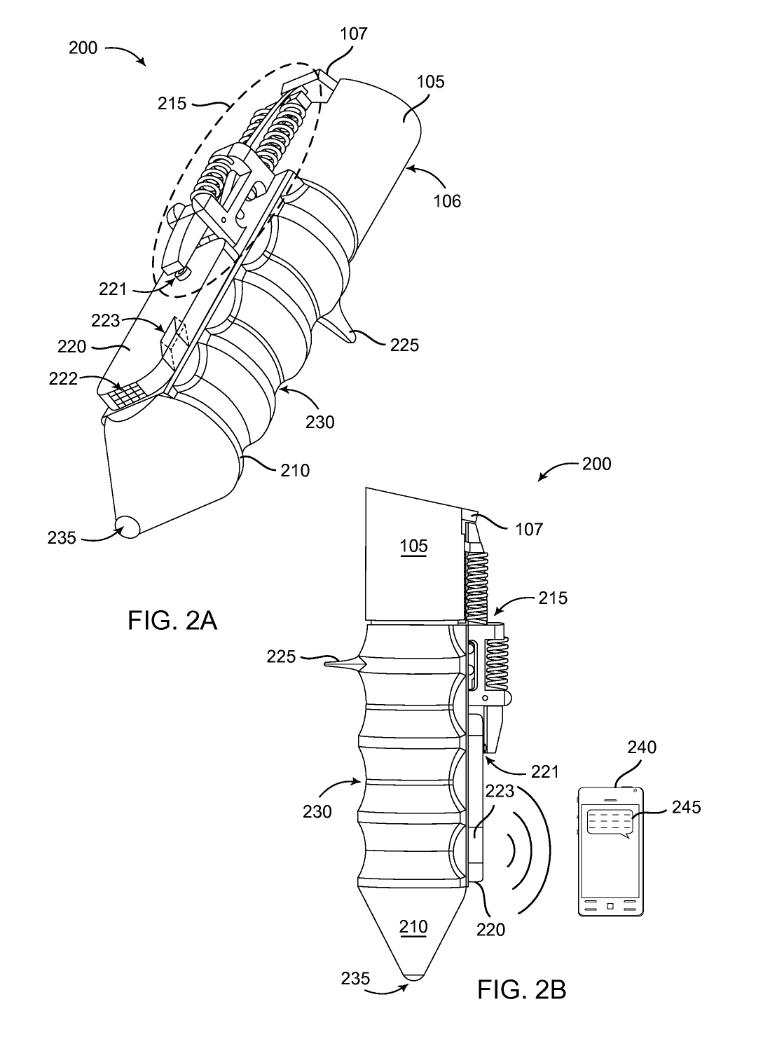

FIG. 1 shows an illustration of a standard off-the-shelf substance dispenser 105, while FIG. 2A shows a 3D illustration of a smart substance dispenser 200, according to one embodiment. FIG. 2B shows a 2D illustration of the smart substance dispenser 200 communicatively coupled to a remote device 240, according to one embodiment. Reference will now be made to FIGS. 1, 2A, and 2B.

The smart substance dispenser 200 may take the form a standard off-the-shelf substance dispenser 105 at least partially encapsulated by a sleeve module 210. The substance dispenser 105 may take the form of a self-defense spray such as pepper spray (e.g., MACE, PEPPER SHOT, ASP, STREETWISE, WILDFIRE, MAGNUM, or DEFENSE TECH) or another type of spray that includes a deterring chemical. Alternatively, the substance dispenser 105 may take the form of a non-defense related spray such as a fire extinguisher. Additionally, the substance dispenser 105 may be an electroshock weapon (e.g., TASER) or the like. The substance dispenser 105 includes a dispensing cap portion 106 and a canister portion 109. The dispensing cap portion 106 comprises a substance release switch 107 and a nozzle 108. The canister portion 109 is used to store the substance prior to release. The substance is released from the dispenser 105 in response to mechanical pressing of the release switch 107, typically by a user. In some embodiments, the dispensing cap portion 106 includes a locking mechanism. The locking mechanism typically takes the form of a groove whereby when the switch 107 is embedded within the groove there can be no downward switch motion to cause release of the substance.

Although reference will be made throughout this application to spray-type substance dispensers, it will be appreciated by those having ordinary skill in the art that embodiments of the invention are also applicable to non-spray dispensers such as TASERs, stun guns, pistols, and rifles.

The sleeve module 210 comprises an actuator 215 and a transmitter module 220. The sleeve module 210 may take the form of a single unitary structure that encapsulates at least a portion of the substance dispenser 105. The sleeve module 210 may be universal in that it can properly encapsulate the substance dispenser 105 associated with one or more manufacturers. Alternatively and/or additionally, the sleeve module 210 may be specifically designed to properly encapsulate various sizes of the substance dispenser 105 associated with the one or more manufacturers. In one embodiment, the sleeve module 210 serves as an auxiliary to the substance dispenser 105 and is therefore manually fitted onto the substance dispenser 105 by a user. In another embodiment, the substance dispenser 105 manufacturer may sell its substance dispenser 105 with the sleeve module 210 already attached thereto. Additionally, the sleeve module 210 may take the form of an aluminum alloy material to allow for a rigid and lightweight design. In some embodiments, the sleeve module 210 may comprise a fluorescent material and/or take the form of a threatening color such as red or orange. Having the sleeve module 210 material glow in the dark allows it to maintain threatening visibility even during night time hours. Maintaining visibility is beneficial to deter assailants and to make passers-by aware that the user has been placed in a dangerous scenario where use of the smart substance dispenser 200 is imminent. It will be appreciated by those having ordinary skill in the art that different materials may be used to achieve the necessary rigidity, lightweight properties, and threatening visibility.

The sleeve module 210 may include one or more protrusions 225. The protrusions 225 allow a user to properly grasp the sleeve module 210 and thus the smart substance dispenser 200 such that when the user releases the substance, the substance is released away from the user's face and body. The protrusions 225 are particularly beneficial considering the smart substance dispenser 200 will likely be employed by the user in haste, while danger toward the user is imminent. Additionally, one or more grooves 230 may be embedded within the sleeve module 210 to offer a tight grip for the user. The one or more grooves 230 may include additional friction (e.g., rubber, silicon, etc.) to reduce the likelihood of slipping from the user's grasp. The sleeve module 210 may include a pointed edge 235 that may be used to strike an assailant in self-defense and/or break glass, for example, in an attempt to flee from the assailant.

The actuator 215 couples the transmitter module 220 to the substance dispenser 105. The actuator 215 may be a spring-triggered mechanism having a first end coupled to the substance release switch 107 and a second end, opposite the first end, coupled to an activation switch 221 of the transmitter module 220 (See FIG. 2A). In the event the substance dispenser 105 has a switch locking mechanism embedded therein, the actuator 215 will be mechanically coupled to the substance release switch 107 when the switch 107 is in the unlocked position. Alternatively, the actuator 215 itself may include a locking mechanism. For example, unless the user appropriately grasps the sleeve module 210, the actuator will remain locked. Alternatively and/or additionally, a biometric sensor on the switch 107 may actuate the locking mechanism.

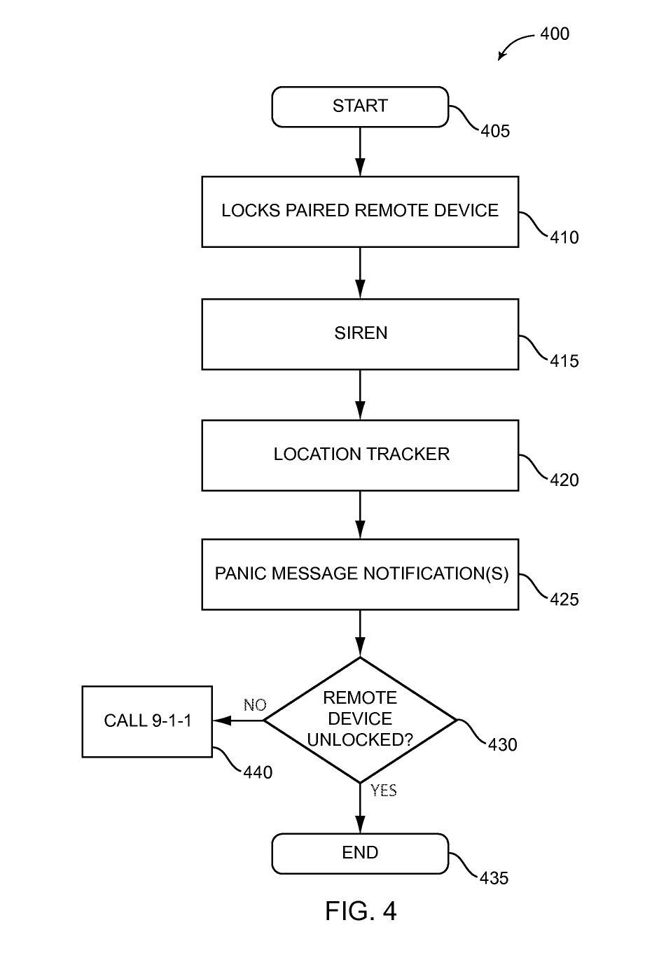

In particular, the actuator 215 converts the user's mechanical stress on the substance release switch 107 to mechanical pressure onto the activation switch 221. For example, when the user initiates a downward mechanical motion of the release switch 107, the second end of the actuator presses against the activation switch 221. In response, the activation switch 221 causes the transmitter module 220 to transmit an activation signal to the remote device 240. The activation signal received by the remote device 240 initiates a defined response by the remote device 240. The defined response will be described in more detail herein with reference to FIG. 4. The remote device 240 may comprise a mobile device such as a mobile phone, tablet, laptop, or any other hand held computing device. Additionally and/or alternatively, the remote device 240 may include any number of different computing devices such as, for example, personal computers (PCs), mainframes, servers or the like.

The transmitter module 220 may comprise a low power transmitter that operates in an unlicensed band. For example, the transmitter module 220 may employ at least one of BLUETOOTH and ZIGBEE technologies or any other wireless technology standard for exchanging data over short distances. In some embodiments, the transmitter module 220 may operate in frequencies requiring a license, such as one or more frequency modulated (FM) or amplitude modulated (AM) bands.

In another embodiment, the transmitter module 210 may communicate with the remote device 240 via other wireless communications technology such as wireless local area network (WLAN), 3G, 4G LTE, etc.

The transmitter module 210 may include at least one antenna, play button 221, battery, charging port, and light emitting diodes (LEDs). The antenna is useful for transmission of the activation signal to the remote device 240. The activation signal may be a standard “PLAY” signal used to initiate a smart dispensing application (e.g., mobile application) stored on the remote device 240. The smart dispensing application and associated methods employed by the remote device 240 will be described in more detail herein.

The battery may take the form of a rechargeable battery, for example, a lithium-ion battery. In one embodiment, the battery may have a maximum 100 mA capacity to allow for at least 1 week of battery life for average usage. Additionally, the charging port may be a small sized port such as a standard, mini-, or micro-USB. It will be appreciated by those having ordinary skill in the art that any charging port may be employed.

The LEDs integrated in the transmitter module 220 are operable to indicate pairing status with the remote device 240. For example, a GREEN light indicates successful pairing, a YELLOW light indicates unsuccessful pairing, and blinking RED indicates low battery. It will be understood that any logical combination of LED color and blinking is included as well. Additionally, although reference has been made to LED other illumination sources are within the scope and spirit of embodiments of the invention. LED was used as an example because of the inherent battery efficiency.

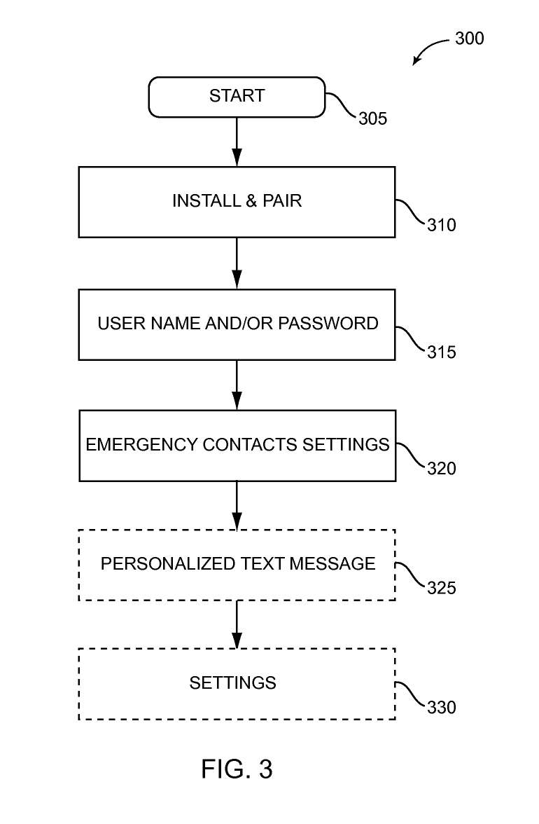

FIG. 3 is a flowchart of a setup method 300 for setting up a smart dispenser application on the remote device 240, according to one embodiment. The method begins at 305, in response to a user of the sleeve module 210 downloading the smart dispenser application from a distribution platform onto the remote device 240. The distribution platform may, for example, be APPLE App Store, GOOGLE Play, WINDOWS Phone Store, BLACKBERRY App World, etc. The remote device 240 may be a smart phone (e.g., iphone, Android phone, Windows phone, Blackberry phone), laptop, tablet, or desktop computer.

At 310, the user installs the downloaded smart dispenser application onto at least one remote device 240 and pairs the remote device 240 with the sleeve module 210. In one embodiment, the user purchases the sleeve module 210 (e.g., either online or from a brick and mortal retail store) and a PIN (personal identification number) associated with the sleeve module 210 is included with the purchase. For example, the PIN may be printed on a document embedded within packaging of the sleeve module 210 such that only a bona fide purchaser can obtain the PIN. An alternative example may include instructions on how to obtain the PIN within the sleeve module 210 packaging.

The PIN is used for authenticating the user as a bona fide purchaser and pairing the purchaser's remote device 240 with the sleeve module 210. In one embodiment, each PIN is allotted a defined number of device authentications while in other embodiments an unlimited number of remote devices may be paired with the sleeve module 210. The pairing of the remote device 240 with the sleeve module 220 occurs in response to the PIN being entered into the downloaded smart dispenser application of the remote device 240. This pairing authentication process can be repeated for other remote devices the user may likely be employing within a vicinity of the sleeve module 210.

At 315, the smart dispenser application initiates a username and/or password request to the user. In one embodiment, the password may comprise more than three alphanumeric characters. Upon receipt of the username and/or password data, the user may obtain access to a settings application within the smart dispenser application.

At 320, the smart dispenser application initiates a request for emergency contacts to be notified when the smart substance dispenser is actuated. The smart dispenser application may have access to contacts stored within the remote device 240. Alternatively and/or additionally, the user may enter additional contacts that are not stored in the remote device 240. For example, the smart dispenser application may import selected contacts from the user's mobile device or may receive user authorization to import contacts from the user's email account or social networking account. The emergency contacts selected and entered into the smart dispenser application settings may include at least one of a telephone number, email address, and social network user name which can receive SMS (short message service), MMS (multimedia message service), email, or other forms of communication. For example, the user may allocate a list of emergency contacts to receive an automatic text message (e.g., group text message) 245 in response to actuation of the smart substance dispenser 200. The automatic message 245 may, for example, take the form of “HELP, I just used my pepper spray!” or the like. Alternatively and/or additionally, the automatic text notification 245 may be transmitted onto the user's social networking wall associated with one or more social networking accounts (e.g., FACEBOOK, TWITTER, etc.).

Optionally, at 325, the user may enter a personalized text message 245 to be automatically transmitted to respective ones of the emergency contacts upon actuation of the smart substance dispenser 200. The personalized messages 245 may recite specific instructions for reacting to the message. For example: “I just used my pepper spray, please call police!” or “I used my TASER, my location is [smart dispenser application fills in location here]!” Additionally and/or alternatively, the personalized message may be posted on the user's social networking wall (e.g., FACEBOOK, TWITTER, etc.)

At 330, the smart substance dispenser application allows for additional settings such as alarm (or siren) tone, alarm (or siren) volume, enable location based services, wait time prior to dialing emergency responder (e.g., 9-1-1 services), and delay prior to transmitting text (e.g., SMS, MMS) notification to emergency contacts. As will be described in more detail herein, upon actuation of the smart substance dispenser 200, the remote device 240 may sound an alarm or siren prior to calling emergency responder services (e.g., 9-1-1 services) and/or the designated emergency contacts.

It will be recognized by those having ordinary skill in the art that the above recited steps may be implemented in different order without departing from the scope of embodiments of the invention. Additionally, the method 300 may include more or fewer steps than those recited above as deemed necessary to carry out the functions of various embodiments discussed above and in the claims.

FIG. 4 shows a flowchart of a panic mode method 400 implemented in response to actuation of the smart substance dispenser 200. At 405, the panic mode method 400 may be implemented via the remote device 240 in response to receiving a “PLAY” signal from the transmitter module 220. In particular, the panic method 400 may be implemented by the smart dispenser application which was downloaded and installed during the setup method 300. The user of the smart substance dispenser 200 may actuate the actuator 215 by pressing on the substance release switch 107 in response to an imminent or current attack by an assailant. The mechanical pressure on the substance release switch 107 (e.g., the release switch of a pepper spray canister) is translated into activation of the switch 221 by the actuator 215. The “PLAY” signal transmitted by the transmitter module 220 to the remote device 240 may, for example, not include embedded information outside of merely initiating the panic method 400 to be implemented by the smart dispenser application via the remote device 240. As such, processing and implementation of the method 400 occurs at the remote device 240 and/or via cloud-based processing services. Leveraging processing remote from the sleeve module 220 allows for increased battery life, minimal battery consumption, and minimal internal sleeve module 220 components.

Additionally, the pairing of the user's remote device(s) with the purchased sleeve module 220 using the PIN prevents the “PLAY” signal from initiating the panic mode method 400 in non-paired devices that are in signal range relative the transmitter module 220. For example, the pairing devices during the set up method prevents the possibility that another's remote device, which is also proximate the user's smart substance dispenser 200, will not implement its panic method 400 (assuming the other's remote device also has the smart dispenser application installed therein).

At 410, the remote device 240 is automatically locked once the “PLAY” signal is received from the sleeve module 220. Automatic locking the remote device 240 prevents the assailant or another individual from accessing the remote device 240, while the user is under attack, and cancelling or altering implementation of the panic method 400. In one embodiment, locking the remote device 240 prevents the assailant from powering down the remote device 240 in addition to accessing the panic method 400 settings on the remote device 240. Locking may take the form of initiating a password protection protocol which is integrated in the remote device 240 by a service provider or manufacturer. For example, smart phone users of most brands can password protect their smart phones. The panic method 400 would automatically initiate the password protect feature already built into the smart phone. As long as the smart device 240 continues to be locked, the method 400 passes control to 415.

At 415, remote device 240 sounds an alarm. The alarm tone and volume may be set during step 330 of the setup method 300. Alternatively and/or additionally, a default tone and volume will be used. The alarm sound may be sufficiently loud to attract attention of passers-by who may call for help or scare away the assailant. The alarm tone may be configured to attract the attention of nearby dogs as well.

At 420, the smart dispensing application on the remote device 240 initiates location-based services. The remote device 240 may determine its geographic location and hence the geographic location of the proximate user. It will be appreciated by those having ordinary skill in the art that various techniques for determining the real-time geographic location of remote devices 240 are known. Some example techniques include: utilizing a service provider's network infrastructure to identify the location of the remote device 240, installation of client software on the remote device 240 to determine its location, and obtaining raw radio measurements from a subscriber identity module (SIM) card within the remote device 240. In one embodiment, the panic method 400 obtains geographic location information of the remote devices 240 from one or more mobile device service providers. The geographic location information may, for example, take the form of global positioning system (GPS) coordinates, nearby street address, cross streets, nearby landmark, or the like.

Although the remote device 240 attempts to determine geographic location upon initiation of the panic method 400, it may take several seconds (e.g., greater than 10 seconds) for the geographic location of the remote device 240, and hence the proximate user, to be determined.

At 425, the smart dispenser application causes the remote device 240 to create and send at least one panic message 245 to the user-defined emergency contacts selected during the setup method 300 described above. The panic messages 245 may be sent simultaneously or asynchronously to all the user-defined emergency contacts. As mentioned above, the panic message 245 may take the form of a mobile phone text message or a text post on a social networking wall (e.g., FACEBOOK, TWITTER, etc.). The panic message 245 may recite “I used my pepper spray, HELP!” or “I used my pepper spray, I′m located at ,” where the smart dispenser application running on the remote device 240 embeds the geographic location in the appropriate location within the panic message 245. Alternatively and/or additionally, the smart dispensing application inserts a hyperlink to a map indicating the geographic location of the remote device 240 and hence the user (i.e., who is proximate the remote device 240). In one embodiment, the panic messages 245 may be transmitted by the remote device 240 to the user-selected emergency contacts immediately after determination of geographic location or several seconds thereafter.

At 430, the smart dispenser application running on the remote device 240 determines whether the password for the remote device 240 has been successfully entered. If the correct password is received by the remote device 240, then the panic method 400 concludes at 435. At 435, the alarm shuts off Otherwise, if the correct password is not yet entered, control passes to 440.

At 440, the smart dispenser application causes the remote device 240 to call emergency responders (e.g., 9-1-1 services, police department, fire department, medical response personnel, etc.). In one embodiment, upon initiation of the emergency responder call, the remote device 240 is automatically placed in speaker mode such that the user may converse with the emergency responder hands-free. In another embodiment, initiation of the emergency responder call enables a BLUETOOTH (or ZIGBEE) voice communication between the remote device 240 and the transmitter module 220. The transmitter module 220 may include a microphone 222 and transceiver 223 to allow for the user to communicate with the emergency responder via the transmitter module 220 itself This is analogous to the BLUETOOTH (or ZIGBEE) earpiece to mobile phone connection which allows for hands free voice calls. Alternatively and/or additionally, the transmitter module 220 may include a speaker (not illustrated) to allow for speaker mode communication between the transmitter module 220 and the remote device 240. Once the call with the emergency responder is established, the alarm from step 415 is paused such that a conversation may take place between the user and emergency responder. Typically, the voice call with the emergency responder will be maintained until emergency response personnel arrive to the scene. Alternatively, once the emergency responder voice call concludes, the alarm resumes at the defined volume until the correct password is entered.

It will be recognized by those having ordinary skill in the art that the above recited steps may be implemented in different order without departing from the scope of embodiments of the invention. Additionally, the method 400 may include more or fewer steps than those recited above as deemed necessary to carry out the functions of various embodiments discussed above and in the claims.

Having described some embodiments of the invention, additional embodiments will become apparent to those skilled in the art to which it pertains. Specifically, although reference was made to a substance dispenser as a self-defense spray, it will be appreciated by those having ordinary skill in the art that any other spray and non-spray mechanisms may be included as embodiments of the invention. For example, the substance dispenser may comprise pepper spray, an electroshock device (e.g., TASER), firearm, or fire extinguisher.

The sleeve module is a standalone component that can be mechanically coupled to a standard-size substance dispenser. The sleeve module may be in several sizes to comply with the various standard dimensions of substance dispensers on the market.

The protrusions may include any other number or tactile formations which achieve the purpose of encouraging the user to orient the smart substance dispenser such that the substance is released away from the user's face and body.

The remote device may comprise a smart phone, laptop, tablet, and any number of computing devices such as, for example, personal computer (PC), mainframes, servers or the like. Additionally, reference has been made to a remote device but embodiments apply to one or more remote devices paired with a single transmitter module of the user's smart substance dispenser. The one or more remote devices having the smart substance dispenser application installed therein. Each of the one or more remote devices may require a respective setup method to be employed by the user. For example, this would allow the different contacts on each remote device to receive text notifications.

While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention.

1. A unitary sleeve configured to encompass at least a portion of a dispenser device, the unitary sleeve comprising:
an actuator coupleable to the dispenser device and actuated in response to mechanical release of a substance from the dispenser device; and
a transmitter module coupled to the actuator and operable to transmit an activation signal to a remote device in response to actuation of the actuator.

2. The unitary sleeve of claim 1, further comprising one or more protrusions configured to encourage proper orientation of the dispenser device such that release of the substance from the dispensing device occurs away from a user.

3. The unitary sleeve of claim 1, further comprising one or more grooves configured to cause a user to tightly grip the unitary sleeve.

4. The unitary sleeve of claim 1, wherein the unitary sleeve is shaped with a pointed head opposite an exposed portion of the dispenser device.

5. The unitary sleeve of claim 1, wherein the actuator comprises a spring triggered mechanism configured to convert the mechanical release of the substance to selection of a button on the transmitter module.

6. The unitary sleeve of claim 1, wherein the actuator comprises a spring triggered mechanism configured to convert the mechanical release of the substance to transmission of the activation signal by the transmitter module.

7. The unitary sleeve of claim 6, wherein the remote device is at least one of a smart phone, tablet, laptop, personal computer (PC), mainframe, server and the like.

8. The unitary sleeve of claim 7, wherein the remote device, upon receipt of the activation signal, is configured to initiate at least one of: locking the remote device, sounding an alarm, determining geographic location of the remote device, transmitting a text message to one or more defined emergency contacts, and establishing a voice call with an emergency response provider.

9. The unitary sleeve of claim 8, wherein the text message transmitted to the one or more defined emergency contacts includes the geographic location of the remote device.

10. The unitary sleeve of claim 8, wherein the remote device is configured to simultaneously transmit the text message to the one or more defined emergency contacts.

11. The unitary sleeve of claim 7, wherein the remote device, upon receipt of the activation signal posts a message onto a user's social networking wall associated with one or more social networking accounts.

12. The unitary sleeve of claim 1, wherein the transmitter module is a low power transmitter employing at least one of BLUETOOTH and ZIGBEE wireless communications standards.

13. The unitary sleeve of claim 12, wherein the transmitter module is communicatively coupled to the remote device.

14. The unitary sleeve of claim 13, wherein the transmitter module includes a transceiver and a microphone configured to allow a user to communicate with an emergency response provider via the transmitter module.

15. The unitary sleeve of claim 1, wherein the dispenser device is a standard off-the-shelf pepper spray device such as at least one of MACE, PEPPER SHOT, ASP, STREETWISE, WILDFIRE, MAGNUM, and DEFENSE TECH.

16. The unitary sleeve of claim 1, wherein the unitary sleeve comprises aluminum alloy material.

17. The unitary sleeve of claim 1, wherein the transmitter module is paired with the remote device prior to transmission of the activation signal.

18. The unitary sleeve of claim 17, wherein the transmitter module is paired with the remote device in response to a personal identification number (PIN) being entered into a smart dispenser application on the remote device.

19. The unitary sleeve of claim 1, wherein the dispenser device is at least one of a pepper spray, an electroshock device, a firearm, and fire extinguisher.

20. The unitary sleeve of claim 1, wherein the substance released is at least one of electrical current, chemical, ammunition, and water.
